(19) United States
(12) Patent Application Publication
(10) Pub. No.: US 2010/0118259 A1
(43) Pub. Date: May 13, 2010

(54) TEMPLE FOR EYEGLASS

(76) Inventor: Giuseppe CONTI, Impruneta (IT)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/618,729

(22) Filed: Nov. 15, 2009

Related U.S. Application Data
(63) Continuation-in-part of application No. PCT/IT2008/000330, filed on May 16, 2008.

(30) Foreign Application Priority Data
May 17, 2007 (IT) PI2007A000060

(51) Int. Cl. G02C 3/00; G02C 5/14

(52) U.S. Cl. 351/111; 351/155

(57) ABSTRACT

An eyeglasses provided with an extensible wire that allows to bring glasses hung around the neck, wherein the two temples are welded and have a loop for the for passage of the wire, as well as means for blocking the wire and means for enabling an easy insertion of the same wire (FIG. 1).

### FIELD OF THE INVENTION

The invention relates to the technical field of the glasses and accessories for glasses.

### BACKGROUND OF THE INVENTION

The term “wire” or “support wire” used in this description indicates a long and thin body made of rope, chain, string, elastic band, flexible wire or other material, intended to support the glasses around the neck of the user for holding the glasses in correspondence of the ends of the temples.

In particular, the invention relates to a temple in which is contained the wire for supporting the glasses; the wire is extracted from the temple when the user wants to drop the glasses on the chest supporting them with the same wire passing around the neck, the wire returning into the temple after the use.

Are known support wires which are fixed to the ends of the temples of glasses in order to allow to take off the glasses without losing the same because said wires keep the eyeglasses hung around the neck like a necklace. Thanks to these wires, when the user remove the glasses, rather than support them on a table, the glasses are kept hung around the neck, supported by the support wire, which passes behind the neck and supports the rim fixed at both ends of the temples.

The support wires of known type are entirely separated from the temples and have the drawback of being inconvenient in use. A first reason is that it is necessary to remember to take said wires together with the glasses and to associate them to the glasses; a second reason is that, when the glasses are stored or are worn, the wire can constitute a hindrance, or can be knotted resulting uncomfortable for storing with folded rim.

The user normally ties the wire around the closed (folded) eyeglass-rim, but not always he is able to act with precision for the haste, and often he found the glasses completely surrounded by knots of ruffled wire, difficult to release.

### SUMMARY OF THE INVENTION

The main aim of this invention is to eliminate the drawbacks mentioned above and to provide an improved temple containing, at least partially, the wire for the support of glasses and allowing its escape and its return inside, quickly and easily, avoiding the hindrance of the user when he stores the glasses.

The main advantages arising from this invention are the following: the wire returns inside a temple, preferably in both temples of the eyeglasses, when the latter are not kept hanging around the neck, without ruffling or create disorder; it isn't necessary to remember to carry the wire since it is always fixed to the glasses, although it has an imperceptible presence; the gasses are not only supported around the neck, but also they are retained on the head when they are worn on the same head; the wire is totally invisible externally.

This result was reached in accordance with the invention, by adopting the idea of providing a temple in two parts harmoniously coupled, for example by ultrasonic welding. The parts are shaped in such a way to form complementary parts of a wall which delimitates a cavity. The temple is provided in combination with a wire or with a part of a wire used to hold glasses. The parts of the peripheral wall are coupled one another for forming a housing for at least a portion of the wire, said housing being substantially shaped as a serpentine, the temple further comprising:
holding means for blocking an end of the wire into the housing;
an opening which is disposed at the end of at least one of two parts; through said opening the wire passing and coming out outwardly when pulled down, with possibility of be adjusted;
means for returning the wire inside its housing when it is not used, as an elastic band, a spring or other means which allows the recovery of the wire.

When the user want to bring glasses hung around his neck, it is sufficient to pull the whole rim and the elastic band stretches up to its extension; then, operating a slight inclination, the wire is blocked, adjusting the length; when, instead, the glasses are to be stored or worn, the wire is pulled horizontally, it is disengaged and it is re-introduced into the temple. For obtaining this result, the temple is preferably provided with releasable means for blocking the wire, once it is extracted, as a flange, a groove, a lock or similar, which blocks the wire and prevents the return of the same in the housing. The guide (serpentine) can form many loops or bends in order to contain the wire for a length even higher in respect to the longitudinal extension of the temple.

Thanks to this feature it is possible to obtain the desired effect using a single temple, but it is clear that it is possible to use two temples according to the invention, for example with a temple provided with a serpentine with only a loop, in order to contain the thickness, utilizing the second temple for containing the wire which doesn't enter in the first one.

In addition, thanks to the use of ultrasonic welding, it is possible to manufacture temple having a very little size, for example by moulding or injection, without notch and internal or external fixing means, such as screws or similar means with a shape which is indistinguishable from that of traditional temples.

In particular, the holding means for blocking an end of the wire inside the housing comprises a tooth which reduces the width of the housing so that when the two parts are coupled the end of the wire disposed above the tooth is crushed and then firmly retained in position near an end of the temple.

Advantageously, the support wire consists of a flexible wire, so that, for extracting the wire, it is sufficient to pull the same wire till the second portion is tightened and maintained in a stretched configuration blocking the wire inside the housing or in another way. The wire returns inside the housing pulled by the force exerted by the elastic wire which reduces the initial stretch.

According to an embodiment, the serpentine has a single loop, said loop being disposed substantially in proximity of the end of the temple opposite to the end in which are located the holding means, the housing being suitable for containing the wire for a length of about twice the length of the temple.

Using a couple of temples of this type, it is possible to collect a quantity of wire which corresponds to four times the length of the temples; this size is sufficient for obtaining the prefixed aims.

If it is necessary to collect a greater quantity of wire, it is possible that the serpentine has many loops arranged longitudinally so that the wire may be disposed on portions which are parallel in respect to the longitudinal extent of the temple; in this way, the guide is suitable to contain widths of the wire multiple of the width of the temple.

According to another embodiment, the serpentine has many loops disposed transversely in respect of the longitudinal extent of the temple, the holding means of the wire being placed distally in respect to the end of the temple provided with the opening from which the wire comes out. The loops or curves are disposed in succession for taking up the greatest longitudinal extension of the temple. The length of wire that can be accommodated with this configuration depends on the number of loops and the transversal size of the temple.

Advantageously, the temple is provided with a block, disposed in the point or in the points of curvature of the serpentine, for preventing the wire to escape from the curvature when the same wire is inserted in the loop. In fact, to facilitate the insertion of the wire in the curve of the serpentine, the wire is inserted through an end of the temple and it is extracted from the opposite end, disposed close to the lens. Then, the wire is inserted in the parallel loop and it is pulled down so that it steps over the curve. At this point, the wire is housed in the housing and the curvature prevents the same wire to from escaping from the same curvature.

According to another aspect, the invention relates to an eyeglass and or a rim for eyeglass comprising at least a temple according to the invention.

Advantageously the temples are two, the wire associated with each temple being single or divided into two parts associated to the respective temple and connected to one another. Any additional features and improvements are the subject of the claims.

### BRIEF DESCRIPTION OF THE DRAWINGS

The characteristics of the invention and the benefits resulting therefrom will be more highlighted by the following detailed description of the attached drawings, wherein:

FIG. 1 shows schematically a perspective view of a glasses on which is mounted a pair of temple according to the invention;

FIG. 2 shows the eyeglasses of FIG. 1 with the temples in exploded configuration;

FIG. 3 shows enlarged details of the ends of the temples of previous figures;

FIG. 4 shows a perspective view from the bottom of one of the temples shown in the previous figures;

FIG. 5 shows a possible embodiment and a possible use of a tool which can be used for associating the wire to the temple.

### DESCRIPTION OF A PREFERRED EMBODIMENT

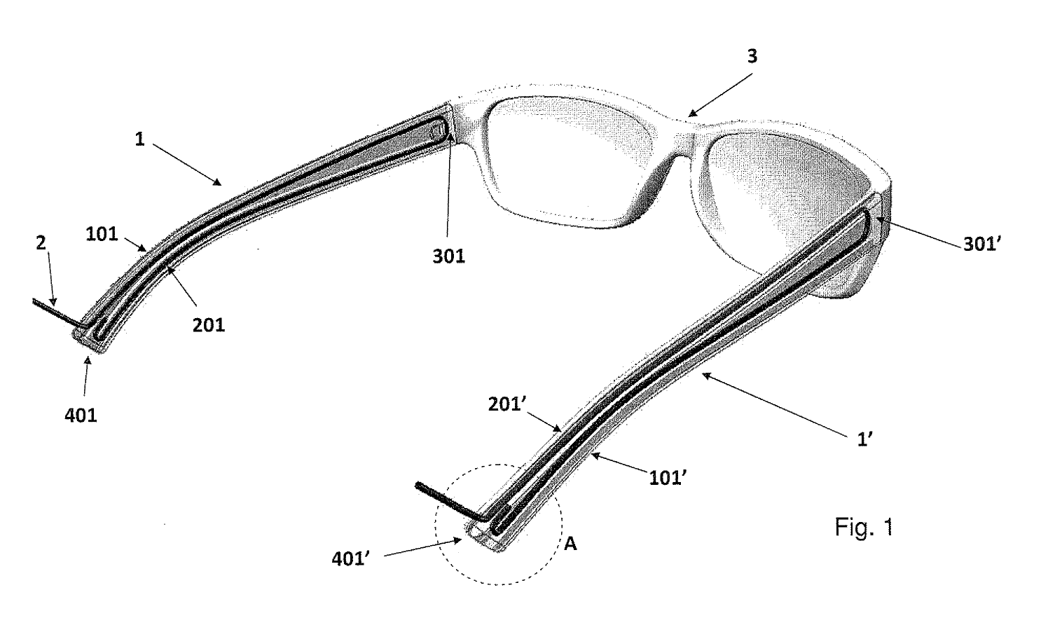

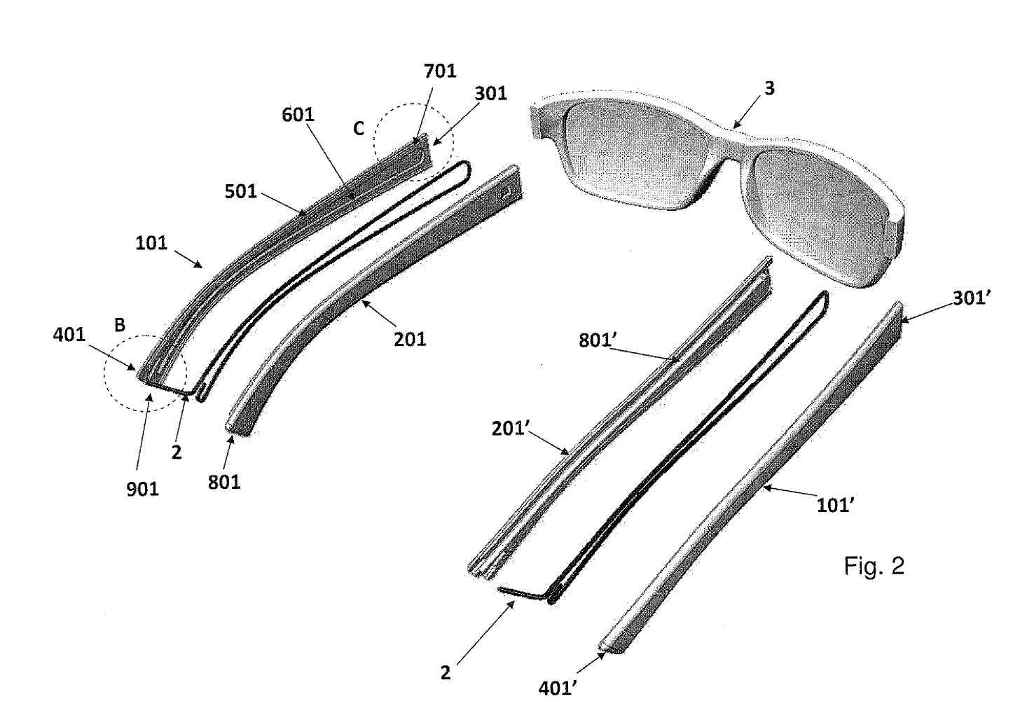

With reference to FIG. 1, the temples 1, 1′ of the eyeglass 3 have a distal end 301, 301′ to be connected to the rim of the lenses and a proximal end 401, 401′ provided with a concavity downwardly oriented (not shown in the drawings) for facilitating the support on the ear of the user. The temples consist of two parts 101, 101′ and 201, 201′ coupled with each other in the longitudinal direction, advantageously by ultrasonic welding. In the figure, the part 201 of the left temple and the part 101′ of the right temple are drawn in transparency so as to highlight how the wire 2, 2′ is disposed within them. As visible in FIG. 2, in this embodiment, the part 101 is internally shaped to define a groove consisting of two parallel longitudinal portions 501, 601, which extend from the proximal end 401 to the distal end 301. Close to the distal end 301 the two portions of groove 501, 601 are connected to form a guide shaped as a coil or serpentine with a single loop (curve) 701 with parallel portions arranged longitudinally in respect to the temple when the two parts 101, 201 are coupled. The part 201 has also a corresponding groove, of smaller depth, which is completed by the main grooves of the part 101 to better define the slot or housing for the wire 2. The groove is visible on the right temple shown in FIG. 2 and indicated with the reference 801′.

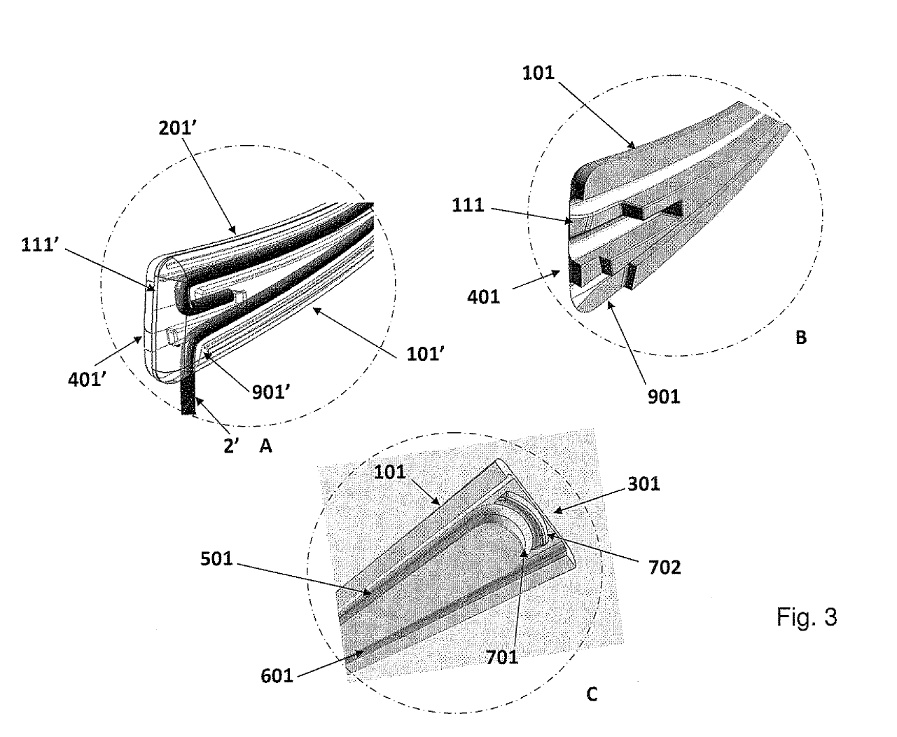

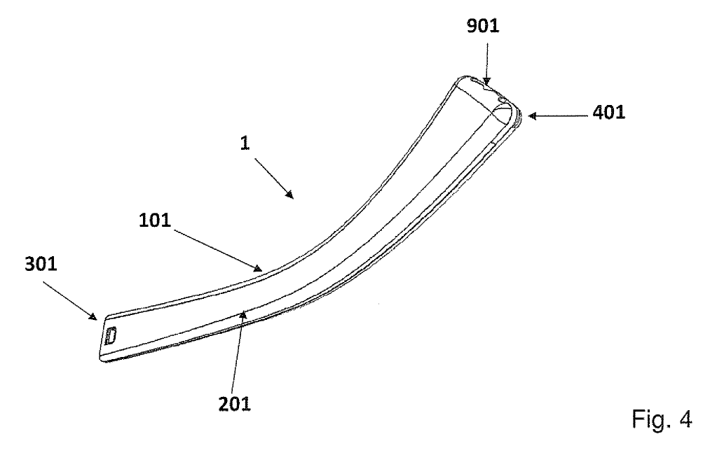

As shown in detail B of FIG. 3 and in FIG. 4, the groove of the part 101 ends, on a side, with an opening 901 for the exit of the wire, and, on the other side, with a sharp double change of direction of 90°. This change of direction, together with the tooth 111 located inside of the final section of the guide that reduces the depth, allows an effective locking of the wire in the guide by joint when the other part 201 is coupled. In this embodiment, both the locking of the wire and the exit opening are disposed in the proximal end 401 of the temple. If the temple is provided with many curvatures of the guide, the fixing of the wire may also be advantageously disposed on the opposite end to ensure the maximum length of the guide.

The wire 2, 2′ is divided into two sections, the first of which is elastic while the second portion is made of rope or other material and corresponds to the part which come out from the device through the opening on the temple 901, 901′. In this way, it is the same wire that carries out the pulling action directed to the inner of the housing, due to the effect of flexibility of its initial portion. Alternatively, or in combination, it is possible that all the wire is elastic or that the temple is provided with any other type of traction means, as a coil spring fixed to an end of the guide. It is possible that elastic are placed in one of the two temples or in both, even of different types. The second temple may be a temple of traditional type to which the ends of the wire associated with the first temple links in the usual ways, for example through an elastic chain (not shown in the figures), the serpentine placed in the first temple housing a quantity of wire sufficient to allow the user to wear glasses.

The locking of the extension of the wire may be advantageously placed in the proximity of the exit opening through a joint or a flange (not shown in figure), for example consisting of two inclined knurled surfaces typically used in releasable clamping devices for wires, or by a tooth, a click device, or other equivalent means.

The temples may be of traditional type, formed by a single body, with longitudinal development (as illustrated in the examples), or they may be formed by a frame which comprises two (or more) little temples joined with each other in correspondence of the distal end, and spaced between themselves in correspondence of the hinge with the front of the rim (this example is not shown). Even in this case will be provided appropriate housings for the wire.

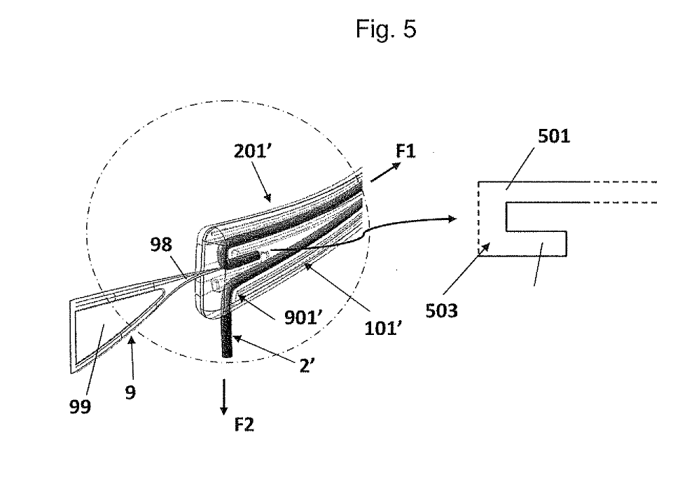

In FIG. 5 is shown a wedge tool 9 used to facilitate the assembly and/or replacement of the wire 2. The wedge tool 9 has a greater section portion 99 which allows the manual grip, for example, between two fingers, and a sharpened portion 98. During the fixing of wire to the temple, once the two parts 101 and 201 (or 101′ and 201′) has been joined with one another, the wire is threaded in the seat formed by the groove 501 (or 501′) and the corresponding groove 801 (801′). The end of the wire 2 which is outside the groove 501 (that is the tail end of the wire if the threaded end is considered as the head end) shall be inserted into the terminal seat 502, that is in that portion of the slot defined at the end of said double change of direction at 90°. At this stage, the tail end of the wire is maintained in the seat 502 by the sharpened end 98 of the wedge 9. The head end of the wire, that is what has crossed the channel formed by the coupled grooves 501 and 801, is pulled, according the direction marked with F1 in FIG. 5. In FIG. 5 is shown only the distal end of an eyeglass temple and, therefore, is not visible the proximal end, in correspondence of which the wire is pulled. The tension of the wire determines the fixing of the tail end of the wire in the area marked with 503 in the detail of FIG. 5, thanks also to the interaction with the tooth 111. (or 111′). Once pulled in correspondence of the distal end, the wire is threaded at the bottom part of the double guide, that is in the part formed by the groove 601, to be then pulled in the opposite direction, toward the direction indicated by the arrow F2, until complete tightening.

Of course, the invention is not limited to what is described and illustrated, but it can be widely varied especially constructively without thereby abandoning the inventive idea above described and the following claims.

What is claimed is:

1) A temple for eyeglasses provided with a wire or a portion of a wire used to hold glasses, comprising:
two coupled parts which are shaped in such a way as to form complementary parts of a peripheral wall which delimitates a cavity forming a housing for at least part of the wire, said housing being substantially shaped as a serpentine;
holding means for blocking an end of the wire into the housing;
an opening which is disposed at the end of at least one of two parts; through said opening the wire passing and coming out outwardly when pulled down, with possibility of be adjusted;
means for returning the wire inside its housing when it is not used, as an elastic band, a spring or other means which allows the recovery of the wire.

2) The temple of claim 1, wherein the temple is provided with releasable means for blocking the wire once extracted, as a flange, a groove, a lock or similar, which blocks the wire and stops moving and prevent the return within its housing.

3) The temple of claim 1, wherein the two parts are coupled by ultrasonic welding.

4) The temple of claim 1, wherein the holding means for blocking an end of the wire into the housing comprises a tooth which reduces the width of the housing so that when the two parts are coupled the end of the wire disposed above the tooth is crushed and then firmly retained in position near an end of the temple.

5) The temple of claim 1, wherein the housing has a sharp double change of direction for facilitating/enabling the locking of the end of the wire.

6) The temple of claim 1, wherein the supporting wire of the eyeglasses consists of a first single portion made of rope, thin chain, or other suitable material, joined with a second portion of elastic wire disposed at an end of the housing, so that, for extracting the wire, it is sufficient to pull the same wire till the second portion is tightened and maintained in a stretched configuration blocking the wire in the inner of the housing or in another way.

7) The temple of claim 1, wherein the wire is pulled inside the housing by the force exerted by the elastic wire which reduces the initial stretch.

8) The temple of claim 1, wherein the serpentine has a single loop, said loop being disposed substantially near the end of the temple opposite to the end in which are located the holding means, the housing being suitable for containing the wire for a length of about twice the length of the temple.

9) The temple of claim 1, wherein the serpentine has many loops arranged transversely in respect of the longitudinal extent of the temple, the holding means of the wire being placed distally in respect to the end of the temple provided with the opening from which the wire comes out.

10) The temple of claim 1, wherein the serpentine has many loops arranged longitudinally so that the wire may be disposed on portions which are parallel in respect to the longitudinal extent of the temple.

11) The temple of claim 1, wherein it is provided with a block, disposed in the point or in the points of curvature of the serpentine, for preventing the wire (2, 2′) to escape from the curvature when the same wire is inserted in the loop.
